(19) United States
(12) Patent Application Publication
(10) Pub. No.: US 2016/0164080 A1
(43) Pub. Date: Jun. 9, 2016

(54) CATHODE FOR LITIUM-AIR BATTERY

(71) Applicant: Hyundai Motor Company, Seoul (KR)

(72) Inventors: Tae Young Kim, Suwon (KR); Won Keun Kim, Suwon (KR); Dong Hui Kim, Suwon (KR); Kyoung Han Ryu, Yongin (KR)

(21) Appl. No.: 14/867,601

(22) Filed: Sep. 28, 2015

(30) Foreign Application Priority Data
Dec. 3, 2014 (KR) 10-2014-0172479

(51) Int. Cl. H01M 4/36; H01M 4/60; H01M 4/133; H01M 4/587; H01M 4/137; H01M 12/08

(52) U.S. Cl. CPC H01M 4/366; H01M 4/137; H01M 12/08; H01M 4/133; H01M 4/587; H01M 4/60; H01M 2004/029

(57) ABSTRACT

The present invention relates to an cathode for a lithium-air battery. More particularly, it relates to an cathode for a lithium-air battery having improved life characteristic because it can suppress volatilization of an electrolyte impregnated in the cathode, and can prevent influx of moisture from outside by forming a bipolar material layer wherein a bipolar material consisting of a hydrophilic ion and a hydrophobic ion is coated on the surface of the cathode.

### CROSS-REFERENCE TO RELATED APPLICATION

This application claims under 35 U.S.C. §119(a) the benefit of Korean Patent Application No. 10-2014-0172479 filed on Dec. 3, 2014, the entire contents of which are incorporated herein by reference.

### TECHNICAL FIELD

The present invention relates to a cathode for a lithium-air battery. The cathode may be formed by applying a bipolar material layer consisting of a hydrophilic ion and a hydrophobic ion on the surface of the cathode, such that volatilization of an electrolyte impregnated in the cathode may be suppressed, and influx of moisture from outside may be prevented thereby improving lifespan of the lithium-air battery.

### BACKGROUND

In order to find a solution for fossil fuel depletion, high oil price, and global warming caused by environmental pollution in sustainable economic growth, interests in not only development of new renewable energy but also energy storage technology for efficient energy use have been rapidly increasing worldwide. For instance, South Korea having energy dependence on foreign countries up to about 97% today will encounter serious pressure on green house gas reduction obligation during the second designated period of the Kyoto Protocol (2013 to 2017), and at the same time, an economical disadvantage such as payment of environmental charge for nonperformance of obligation, may be expected.

Accordingly, development of energy storage technology for efficient energy use has been considered as an important business, which can determine the future for the Korean economy, and further, it may be expected to rapidly grow as the next generation business that can secure energy security by reducing energy dependence on other countries.

Thus, in order to enhance these problems, developments in technologies for battery system having high energy density may be needed, and as a solution to this, advanced countries such as the United States, Japan and the like start getting interested in development of the lithium-air battery.

For example, the lithium-air battery which can be supplied with unlimited oxygen in the air may have an advantage of having high energy density, because it can store a large amount of energy through an air electrode having large specific surface area. Energy density of lithium metal may be of about 11140 Wh/kg close to energy density of gasoline and diesel fuels, and theoretically, high energy density may be obtained because the battery may receive supply of oxygen from outside. When calculating theoretical energy density of the lithium-air battery, the battery may provide the highest energy density of about 3500 Wh/kg among current candidates for the next-generation secondary battery, which may be about 10 folds higher energy density than a lithium ion battery.

The lithium-air battery is a battery system whose anode uses lithium and cathode (air electrode) uses oxygen in the air, respectively, as an active material. Oxidation and reduction of the lithium occurs in the anode, and oxidation and reduction of the oxygen flowed from outside occurs in the cathode.

As shown in the following Chemical Formulas 1 and 2, in the lithium-air battery, the lithium metal of the anode is oxidized during discharging reaction, thereby forming lithium ions and electrons, and then the lithium ions move to the cathode through an electrolyte, and the electrons move to the cathode through an external conducting wire or a collector. Oxygen contained in the external air flows into the cathode, and then reduced by electrons to form Li₂O₂. Charging reaction progresses counter to the reaction.

(anode): Li→Li⁺+e⁻ Chemical Formula 1

(cathode): O₂+2Li⁺+2e⁻→Li₂O₂ Formula 2

Referring to Formula 2, the lithium oxide (Li₂O₂) is produced by reaction of the lithium and the oxygen, and this reaction occurs at 3-phase interface of solid (conductive material)-liquid (electrolyte)-gas (oxygen). Accordingly, because the battery is efficiently charged and discharged when the three-phase interface is provided suitably, proper control thereof has been studied as the most importance issue for the lithium-air battery.

On the other hand, when using a liquid electrolyte to the lithium-air battery, which must need air (oxygen) circulation, there may be problems, for example, volatilization of the electrolyte solution may occur as the reaction proceeds, and it may be difficult to provide the electrolyte to a reaction site so that the reaction happens actively.

Accordingly, studies for replacing the organic-type electrolyte to solid-type or hybrid-type electrolyte has been conducted, but such limitations have not been overcome because the electrolyte may have more complex structure and lower energy density than the organic-type lithium-air battery.

Thus, it is urgently needed to develop a lithium-air battery which prevents volatilization of an organic electrolyte and receives proper supply of three-phase interface.

The above information disclosed in this Background section is only for enhancement of understanding of the background of the invention and therefore it may contain information that does not form the prior art that is already known in this country to a person of ordinary skill in the art.

### SUMMARY

In preferred aspect, the present invention provides a cathode (air electrode) for a lithium-air battery to address the above-described problems in the related arts. Due to the cathode of the present invention, volatilization of an electrolyte may be suppressed and smoothly the electrolyte may be supplied efficiently to a reaction site where reaction occurs.

However, the present invention may not be limited to the above-mentioned objects of the cathode, but the cathode of the present invention will be clearly understood for other purposes by a skilled worker in this technical field from the following descriptions.

In one aspect, the present invention provides an cathode for a lithium-air battery, which may include: a structure; a carbon material coated on the structure; and a bipolar material layer, in particular, the bipolar material layer may be formed by coating or attaching a bipolar material to the surface of the structure. In particular, the bipolar material layer may be formed as a polymer brush structure. Further, in particular, bipolar material may comprise a hydrophobic ion moiety facing to the surface of the structure, and a hydrophilic ion moiety located opposite to the hydrophobic ion moiety in the polymer brush structure.

The hydrophilic ion moiety may be any one selected from the group consisting of imidazolium, pyrazolium, triazolium, thiazolium, oxazolium, pyridazinium, pyrimidinium, pyrazinium, ammonium, phosphonium, pyridinium, pyrrolidinium, optionally substituted with an alkyl group having 1 to 15 carbon atoms, and a mixture thereof. Alternatively, the hydrophilic ion moiety may be any one selected from the group consisting of ethylmethyl-imidazolium, butylmethyl-imidazolium, hexylmethyl-imidazolium, octylmethyl-imidazolium, ethyldimethyl-imidazolium, butyldimethyl-imidazolium, hexyldimethyl-imidazolium, octyldimethyl-imidazolium and a mixture thereof.

The hydrophobic ion moiety may be any one selected from the group consisting of PF₆⁻, BF₄⁻, CF₃SO₃⁻, N(CF₃SO₂)₂⁻, N(C₂F₅SO₂)₂⁻, C(CF₂SO₂)₃⁻ and a mixture thereof.

The bipolar material layer may be coated or attached to one side or both sides of the structure.

Further, the bipolar material layer may be formed by coating the bipolar material to the surface of the structure, for example, by any one method of dip coating, die coating, roll coating, comma coating and a combination method thereof. In particular, the bipolar material may be coated or attached to the surface of the structure, and then the carbon material may be coated on the structure.

Alternatively, the carbon material may be coated on the structure, and then the bipolar material may be coated or attached to the surface of the structure.

In another aspect, the present invention provides a lithium-air battery comprising the cathode as described herein.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary cross-sectional view illustrating an exemplary cathode for an exemplary lithium-air battery according to an exemplary embodiment of the present invention;

FIGS. 2A-2B are exemplary reference views for illustrating one of exemplary bipolar material layer forming position according to exemplary embodiments of the present invention;

FIG. 3 is an exemplary reference view for explaining how an exemplary hydrophilic ion may suppress volatilization of an electrolyte according to an exemplary embodiment of the present invention;

FIG. 4 is an exemplary reference view for explaining how an exemplary hydrophobic ion may prevent invasion of moisture from outside according to an exemplary embodiment of the present invention; and

FIG. 5 is an exemplary cross-sectional view illustrating an exemplary lithium-air battery according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

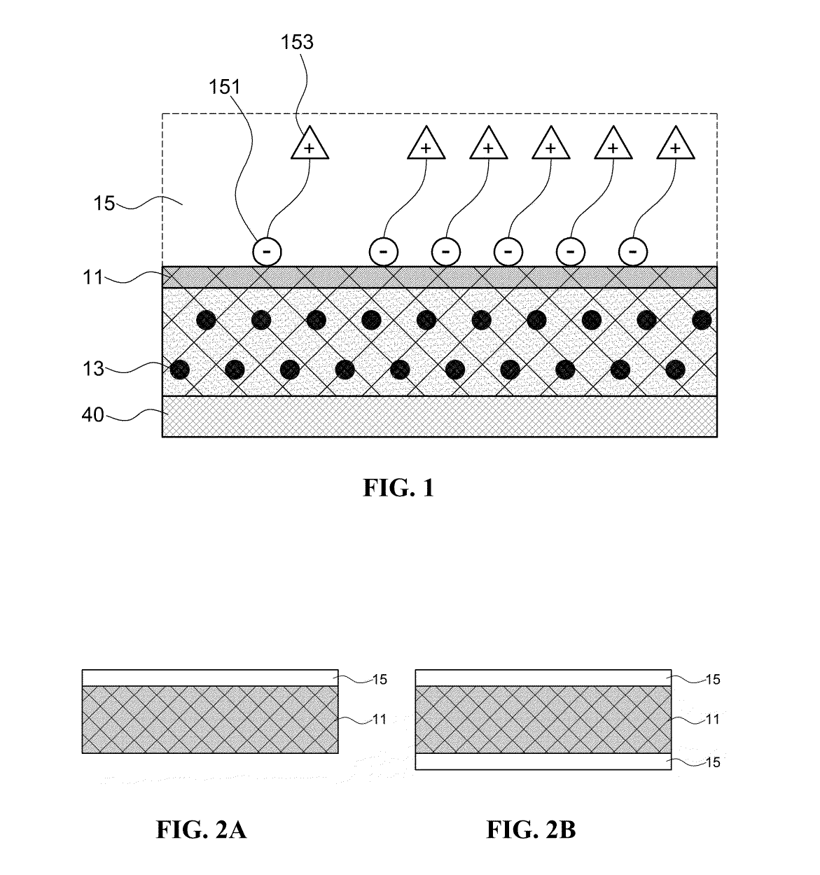

Referring to FIG. 1, the cathode for a lithium-air battery (herein after, ‘cathode’) according to an exemplary embodiment of the present invention may include: a structure 11; a carbon material 13 coated on the structure 11; and a bipolar material layer 15. In particular, the bipolar material layer 15 may be formed by coating or attaching a bipolar material to the surface of the structure 11, and for example, the bipolar material layer 15 may be formed as a polymer brush structure.

The “bipolar material”, as used herein, may be formed of a molecule which may simultaneously contain two distinctive or opposite properties, e.g. chemical or physical properties. The molecule of bipolar material, for example, may include two moieties which are distinctive ionic charges, hydrophobicity or hydrophilicity, sizes, polarity, dipoles, van der Waals force and combinations thereof, and the two moieties may be at least apart within the molecule, without limitations in distance therebetween, locations, or directions thereof. Exemplary bipolar material according to an exemplary embodiment of the present invention may contain a hydrophilic ion moiety a first terminus and a hydrophobic ion moiety at a second terminus of the molecule, and the hydrophobic ion moiety may face and interact with a surface of a substrate/structure and the hydrophilic ion moiety located opposite end to the hydrophobic ion moiety in the molecule may face toward water, aqueous or polar material. In further example, in the exemplary bipolar material of the present invention, the hydrophilic ion moiety may be positively or negatively charged, such that when the hydrophilic ion moieties are arranged at same direction, repulsive forces may be generated therebetween.

The “polymer brush structure” as used herein, means a structure formed by a bundle of polymers or filaments from the polymers as being attached or fixed, on one end, to a base or other object. The polymer brush structure may further have the other end of the polymers, which is opposite side from the end attached or fixed to the base, as being substantially freely moving, or partially freely moving at opposite direction from the base.

The structure 11 may be a base forming a skeleton or a base of the cathode. The structure 11 of the cathode may be formed in various shapes, particularly to provide greater surface area. For example, it may be formed in a sheet shape having large surface area.

The carbon material 13 may be coated inside and outside of the structure 11. Further, in order to further improve conductivity of the cathode, metal sheet, mesh or foam shaped structure such as carbon sheet, nickel mesh, nickel foam, aluminum mesh, aluminum foam and the like may be used, without limitation.

The carbon material 13 may be a constitution playing a role as a conductive material, which provides conductivity to the cathode. When an electron generated by the above Chemical Formula 1 moves to the cathode through a collector or an external conducting wire, it may provide an electron to a three-phase interface or reaction site by keeping the electrons in the cathode.

The carbon material 13 may be a space where oxygen, a lithium ion and an electron flowing into the cathode may react, and thus, greater specific surface area thereof may be provided. The carbon material 13 may be selected from the group consisting of natural graphite, artificial graphite, carbon black, acetylene black, Ketjen black, carbon fiber, carbon nanotube, porous carbon (Ordered Mesoporous Carbon) and a combination thereof.

The carbon material 13 may be coated on the structure together with a binder for improving binding strength with the structure. The binder may be selected from the group consisting of polyvinylalcohol, carboxymethylcellulose, hydroxypropylcellulose, diacetylcellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon.

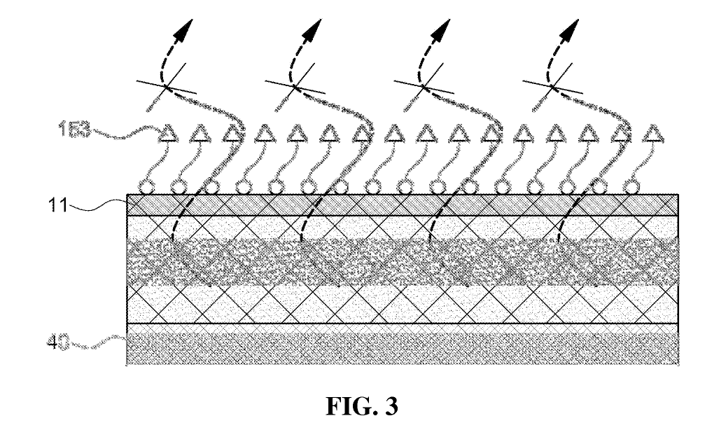

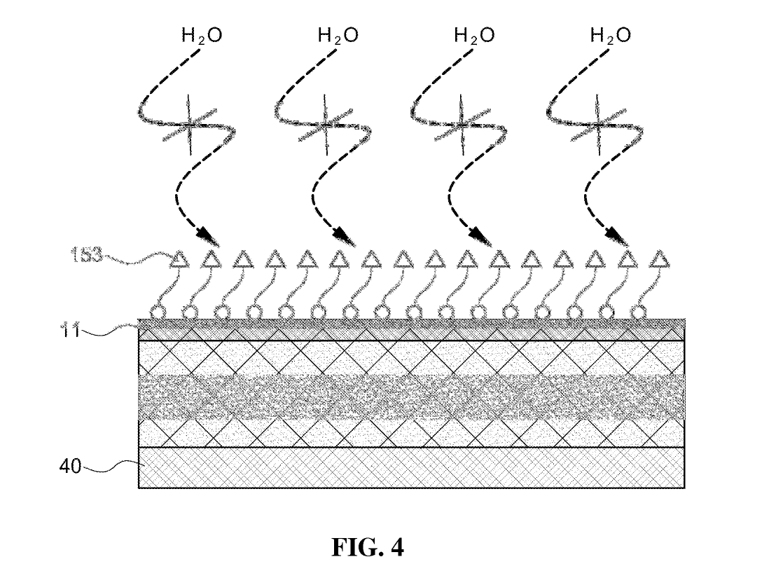

The bipolar material layer 15 may be formed by coating or attaching the bipolar material on the surface of the structure 11, such that the bipolar material layer 15 may have a polymer brush structure as shown in FIGS. 3-4. As such, the bipolar material layer 15 may suppress volatilization of an electrolyte 40 impregnated in the structure, or alternatively, the carbon material-coated structure, by forming a film on the surface of the structure.

The bipolar material, as used herein, may be a zwitterion, and the zwitterion may include both a positively charged moiety and a negatively charged moiety, or alternatively may include both acidic moiety and a basic moiety, for example, an amino acid molecule (NH₂—R—COOH) having an acidic group (—COOH) and a basic group (—NH₂). The zwitterion, such as NH₃⁺—R—COO⁻, generally has differently charged moieties at a different position in one molecule due to shift of proton (H⁺), thereby generating an electrical dipole. Further, such zwitterion may have a hydrophilic character and a hydrophobic character in one molecule.

Thus, the bipolar material may contain a hydrophobic ion moiety 151 facing to the surface of the structure, and a hydrophilic ion moiety 153 locating at opposite site to the hydrophobic ion.

According to an exemplary embodiment, the structure 11, carbon material 13 and electrolyte 40 may be made of organic materials, thereby having hydrophobic character. Since materials having the same polarity are mixed substantially with one another and materials having different polarity are not mixed one another, when the bipolar material is contacted to the structure, the hydrophobic ion moiety 151 may be located at the surface of the structure 11, but the hydrophilic ion moiety 153 may be in distance from the structure 11. Thus, each molecule of the bipolar material may have a polymer brush structure as shown in FIG. 1.

Further, since, each molecule of the bipolar material may have the same charge at a similar position, and thus, electrical repulsion may be generated therebetween and push out each other. For example, the ends of the molecules of the bipolar material may outgrow from the surface of the structure, and may form a brush like structure.

The hydrophilic ion contained in any one molecule of the bipolar material, for example, is not mixed with the structure having different polarity when the bipolar material layer is strongly pressed, and repels because it has the same type charge at the same position with neighboring molecules. Thus, each molecule of the polymer brush can maintain the structure shown in FIG. 1 without mixed or twisted one another.

When coating or attaching the bipolar material, the hydrophobic ion 151 borders to the structure 11, the carbon material 13 or the electrolyte 40, which have the same polarity, at the surface of the structure, and therefore, there is no need to add a separate binder, thereby improving process efficiency and economical efficiency.

Referring to FIG. 1, an empty space above the structure 11 (specifically, upper space of the bipolar material layer 15) also plays a role of an air path, which is a path where air flows into the cathode, but the conventional lithium ion battery has a problem that the electrolyte 40 impregnated in the cathode volatilizes through the air path.

As shown in FIG. 1, the present invention provides an exemplary cathode that may prevent volatilization of the hydrophobic electrolyte 40, because the hydrophilic ion moiety 153 may be located between the air path and the electrolyte. In other words, due to such character that different polarities are not mixed well, the hydrophilic ion 153 moiety may function as a kind of a film to the electrolyte 40.

The hydrophilic ion moiety 153 may be any one selected from the group consisting of imidazolium, pyrazolium, triazolium, thiazolium, oxazolium, pyridazinium, pyrimidinium, pyrazinium, ammonium, phosphonium, pyridinium, pyrrolidinium, optionally substituted with an alkyl group having 1 to 15 carbon atoms, and a mixture thereof, and preferably, it may be any one of ethylmethyl-imidazolium, butylmethyl-imidazolium, hexylmethyl-imidazolium, octylmethyl-imidazolium, ethyldimethyl-imidazolium, butyldimethyl-imidazolium, hexyldimethyl-imidazolium, octyldimethyl-imidazolium and a mixture thereof.

The hydrophobic ion moiety 151 may be any one selected from the group consisting of PF₆⁻, BF₄⁻, CF₃So₃⁻, N(CF₃SO₂)²⁻, N(C₂F₅SO₂)²⁻, C(CF₂SO₂)₃⁻ and a mixture thereof.

However, examples of the hydrophilic ion moiety 153 and the hydrophobic ion moiety 151 may not be limited thereto, and any bipolar material containing the hydrophilic ion moiety and the hydrophobic ion moiety can be used for the bipolar material layer.

The cathode for a lithium-air battery according to an exemplary embodiment of the present invention may be manufactured by forming the bipolar material layer by coating or attaching the bipolar material to the surface of the structure, and then coating the carbon material to the structure.

Alternatively, the cathode for a lithium-air battery according to an exemplary embodiment of the present invention may be manufactured by coating the carbon material to the structure first, and then forming the bipolar material layer by coating or attaching the bipolar material to the surface of the structure.

As described above, when coating or attaching the bipolar material to the surface of the structure, the polymer brush structure may be spontaneously formed. Thus, the cathode shown in FIG. 1 may be identically manufactured or assembled, although order of attaching the bipolar material and coating the carbon material is changed. Thus, a manufacturing method may be optimized depending on manufacturing environment, process condition and the like, thereby improving process efficiency.

Any methods for coating or attaching the bipolar material to the surface of the structure generally known in the related arts may be used without limitation. In particular, method of coating the bipolar material to the structure may be used, so as to make the process simple, and to be evenly dispersed and coated or attached on the structure. For example, a solution manufactured by dissolving or dispersing the bipolar material in a solvent may be coated on the surface of the structure and the solvent may be removed thereafter. Thus, the bipolar material may be coated on the surface of the structure by any one method of dip coating, die coating, roll coating, comma coating or a combination method thereof.

Depending on type, size and the like of the lithium-air battery, the bipolar material layer 15 may be formed one side of the structure 11 as shown in FIG. 2A, and formed both sides of the structure 11 as shown in FIG. 2B.

As shown in FIG. 3, the hydrophilic ion 153 may be formed as a film surrounding the structure 11, thereby preventing volatilization of the hydrophobic electrolyte 40. Thus, the present invention may provide a lithium-air battery having extended lifespan and improved discharge capacity without increasing the amount of the electrolyte 40 impregnated in the lithium-air battery.

Further, because the amount of the electrolyte 40 may be reduced, manufacturing cost of a lithium-air battery may be reduced and economical efficiency may be improved.

In addition, because the electrolyte 40 is not volatilized and impregnated in the cathode, a three-phase interface or reaction site where charging and discharging reactions occur may be provided, thereby providing a lithium-air battery having increased battery reaction efficiency.

As shown in FIG. 4, the hydrophobic ion 151 may be attached to the surface of the structure 11, thereby preventing flow of moisture into the cathode through the air path. Thus, a lithium-air battery in which battery failure by moisture and the like may be prevented, is provided.

### EXAMPLES

The following examples illustrate the invention and are not intended to limit the same.

### Example

(1) Manufacture of Cathode

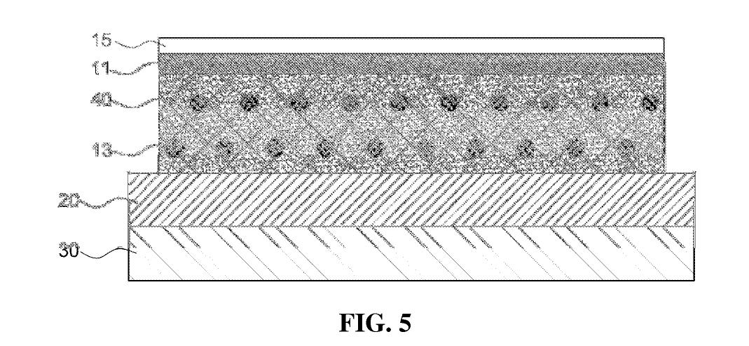

1) As shown in FIG. 5, Ketjen black as a carbon material 13 was mixed with polyvinylidene fluoride (PVdf) as a binder at about 7:3 weight ratio to prepare a slurry, and then the slurry was coated on a carbon sheet as a structure 11 using a doctor blade. Then, the structure 11 was dried at a temperature of about 100° C. in a vacuum oven for about 3 hours.

2) Cyanoethyl pullulan as a bipolar material was dissolved in acetone to prepare a about 3% wt/vol cyanoethyl pullulan solution, and then impregnating the dried structure in the solution to manufacture an cathode containing a bipolar material layer 15 loaded with the cyanoethyl pullulan of about 3 g/m².

(2) Manufacture of Lithium-Air Battery

1) A separation membrane 20 and a anode 30 were assembled to the cathode in order, and then an electrolyte 40 was impregnated therein to manufacture a lithium-air battery as shown in FIG. 5. At this time, the cathode was assembled to expose the bipolar material layer 15 of the cathode outside.

As the separation membrane, a glass filter (Whatman) having a diameter of about 16φ was used as the anode, a lithium foil having thickness of about 500 μm and a diameter of about 16φ was used, and the electrolyte was prepared by dissolving about 1M LiTFSI lithium salt in tetraethylene glycol dimethyl ether (TEGDME) solvent and about 60 ml was used for impregnation.

2) The lithium-air battery was assembled as a coin cell, and as the cap part of the coin cell, a cap having 3 holes as an air hole so as to allow inflow of the air from outside was used. The cell was assembled to make the bipolar material layer face toward the air hole.

### Comparative Example 1

A coin cell-type lithium-air battery not containing the bipolar material layer was manufactured. The method of Example was repeated except that no bipolar material layer was included to manufacture a lithium-air battery.

### Comparative Example 2

A coin cell-type lithium-air battery containing a polyolefin-based film shield instead of the bipolar material layer was manufactured. The method of Example was repeated except for replacing the bipolar material layer with the polyolefin-based film shield to manufacture a lithium-air battery.

### Measuring Example

The lithium-air batteries manufactured by Example and Comparative Examples 1 and 2 were subjected to charging/discharging test. Life cycle number of each lithium-air battery at capacity where capacity cut-off condition is maintained was checked. The charging/discharging test was conducted by repeating constant current-constant voltage charging (about 4.3 V cut-off) of current density of about 385 mAh/cm² and constant current discharging (about 2.0 V cut-off) at discharge depth of about 20% level (about 1 mAh/cm² capacity cut-off condition), based on about 5 mAh/cm² of capacity per unit area of the lithium-air battery manufactured at room temperature. The results are shown in the following Table 1.

TABLE 1

| | | Life Evaluation |
|---|---|---|
| | Condition | (Cycle Number) |
| Comparative Example 1 | No shield | 9 Cycle |
| Comparative Example 2 | Film Shield | 19 Cycle |
| Example | Bipolar Material Layer | 95 Cycle |

As shown above Table 1, Example may have about 10 folds, about 5 folds higher life cycle number than Comparative Examples 1 and 2.

Thus, according to Measuring Example, the lithium-air battery according an exemplary embodiment of the present invention containing the bipolar material layer may suppress volatilization of the electrolyte, and may further prevent invasion of moisture from outside, thereby having large effect on life characteristic, compared to the conventional lithium-air battery.

The cathode for a lithium-air battery including the above configuration according to the present invention has the following effects.

The present invention has an effect of providing a cathode for a lithium-air battery, which has reduced amount of an electrolyte and reduced cost and improved economical efficiency by a hydrophobic ion of a bipolar material suppressing volatilization of an electrolyte.

The present invention has an effect of providing a cathode for a lithium-air battery, which has improved battery reaction efficiency by providing enough three-phase interface (reaction site), because it may contain suitable amount of electrolyte inside of an cathode.

The present invention has an effect of providing a cathode for a lithium-air battery, which has dehumidifying effect of a hydrophobic ion of a bipolar material blocking inflow of moisture from outside (air path). The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An cathode for a lithium-air battery, which comprises:
a structure;
a carbon material coated on the structure; and
a bipolar material layer comprising a bipolar material,
wherein the bipolar material comprises a hydrophobic ion moiety facing a surface of the structure and a hydrophilic ion moiety located opposite to the hydrophobic ion.

2. The cathode for a lithium-air battery of claim 1, wherein the bipolar material layer is formed by coating or attaching the bipolar material to the surface of the structure.

3. The cathode for a lithium-air battery of claim 1, wherein the bipolar material layer is formed by attaching the bipolar material to the surface of the structure.

4. The cathode for a lithium-air battery of claim 1, wherein the bipolar material layer is formed to have a polymer brush structure.

5. The cathode for a lithium-air battery of claim 1, wherein the hydrophilic ion moiety is one selected from the group consisting of imidazolium, pyrazolium, triazolium, thiazolium, oxazolium, pyridazinium, pyrimidinium, pyrazinium, ammonium, phosphonium, pyridinium, pyrrolidinium, optionally substituted with an alkyl group having 1 to 15 carbon atoms, and a mixture thereof.

6. The cathode for a lithium-air battery of claim 1, wherein the hydrophilic ion moiety is one selected from the group consisting of ethylmethyl-imidazolium, butylmethyl-imidazolium, hexylmethyl-imidazolium, octylmethyl-imidazolium, ethyldimethyl-imidazolium, butyldimethyl-imidazolium, hexyldimethyl-imidazolium, octyldimethyl-imidazolium and a mixture thereof.

7. The cathode for a lithium-air battery of claim 1, wherein the hydrophobic ion moiety is one selected from the group consisting of PF₆⁻, BF₄⁻, CF₃SO₃⁻, N(CF₃SO₂)₂⁻, N(C₂F₅SO₂)₂⁻, C(CF₂SO₂)₃⁻ and a mixture thereof.

8. The cathode for a lithium-air battery of claim 1, wherein the bipolar material layer is formed on one side or both sides of the structure.

9. The cathode for a lithium-air battery of claim 1, wherein the bipolar material layer is formed by coating the bipolar material to the surface of the structure by any one method selected from dip coating, die coating, roll coating, comma coating and a combination method thereof.

10. The cathode for a lithium-air battery of claim 1, wherein the bipolar material is coated or attached to the surface of the structure, and then the carbon material is coated on the structure.

11. The cathode for a lithium-air battery of claim 1, wherein the carbon material is coated on the structure, and then the bipolar material is coated or attached to the surface of the structure.

12. A lithium-air battery comprising a cathode of claim 1.
